(19) United States
(12) Patent Application Publication
(10) Pub. No.: US 2014/0113172 A1
(43) Pub. Date: Apr. 24, 2014

(54) ENERGY STORAGE DEVICE, BATTERY WITH TWO OF SAID ENERGY STORAGE DEVICES, AS WELL AS A METHOD FOR INTERCONNECTING SAID ENERGY STORAGE DEVICES

(71) Applicant: Li-Tec Battery GmbH, Kamenz (DE)

(72) Inventor: Michael Enghardt, Dresden (DE)

(73) Assignee: LI-TEC BATTERY GMBH, Kamenz (DE)

(21) Appl. No.: 14/059,908

(22) Filed: Oct. 22, 2013

Related U.S. Application Data
(60) Provisional application No. 61/717,167, filed on Oct. 23, 2012.

(30) Foreign Application Priority Data
Oct. 23, 2012 (DE) 10 2012 020 799.9

(51) Int. Cl. H01M 10/6551; H01M 2/10; H01R 43/00; H01M 2/02

(52) U.S. Cl. CPC H01M 10/5046; H01M 2/024; H01M 2/1077; H01R 43/00
USPC 429/120; 429/163; 429/159; 29/861

(57) ABSTRACT

An energy storage device includes an electrochemical electrode assembly, a substantially cuboid housing having a first housing wall and a second housing wall arranged substantially perpendicular to one another, a first cell terminal of first polarity and a second cell terminal of second polarity, the cell terminals extending from the first housing wall, the first cell terminal including a first contact area having a first normal vector, the second cell terminal configured with a substantially plate-shaped connecting leg that sectionally extends beyond the second housing wall and includes a second contact area having a second normal vector having the same direction as the first normal vector and reversed orientation.

### CROSS-REFERENCE TO RELATED APPLICATIONS

The present application claims the benefit of U.S. Provisional Patent Application Ser. No. 61/717,167, filed Oct. 23, 2012, the entire content of which is incorporated herein by reference. The present application also claims priority to German Patent Application 10 2012 020 799.9, filed Oct. 23, 2012, the entire content of which is incorporated herein by reference.

### DESCRIPTION

The present invention relates to an energy storage device (secondary cell), a battery having at least two of said energy storage devices, as well as a method for interconnecting said energy storage devices. The invention is described in conjunction with lithium-ion batteries for supplying motor vehicle drives. It is noted that the invention can also be used independent of the specific battery design or energy storage device chemistry or independent of the type of drive supplied.

Batteries having a plurality of adjacently arranged and interconnected energy storage devices or secondary cells, particularly for supplying motor vehicle drives, are known in the prior art.

The expenditure involved in manufacturing various types of batteries is at times seen to be problematic.

It is an object of the invention to provide a battery which can be manufactured at lower expenditure.

This object is accomplished by an energy storage device in accordance with claim 1. Claim 9 describes a battery comprising at least two said energy storage devices. The objective is also accomplished by a method for interconnecting said two energy storage devices in accordance with claim 12. Preferential further developments of the invention constitute the subject matter of the subclaims.

An energy storage device according to the invention is particularly designed as an electrochemical secondary cell, particularly intended for a secondary battery and particularly designated for supplying a motor vehicle. The energy storage device comprises an electrochemical electrode assembly which is designed to at least intermittently provide an electrical voltage, particularly a terminal voltage, particularly for supplying energy to a load. The energy storage device further comprises a substantially cuboid housing which is designed to at least partially, preferably predominantly, particularly preferentially completely accommodate the electrode assembly. To that end, the housing comprises at least one first housing wall and one second housing wall, wherein the first housing wall is arranged substantially perpendicular to the second housing wall. The energy storage device further comprises a first cell terminal of first polarity and a second cell terminal of second polarity, wherein the electrical voltage of the electrode assembly can be at least intermittently tapped at the cell terminals. The first cell terminal and the second cell terminal extend from the first housing wall into the environment of the energy storage device. The first cell terminal comprises a first contact area having a first normal vector \vec{N₁}. The second cell terminal is configured with a substantially plate-shaped connecting leg, sections of which extend beyond the second housing wall. The connecting leg comprises a second contact area having a second normal vector \vec{N₂}. The second normal vector \vec{N₂} points in the same direction as the first normal vector \vec{N₁}. The second normal vector \vec{N₂} has a reversed orientation to the first normal vector \vec{N₁}.

The second contact area is preferably designed and arranged particularly relative to the connecting leg such that the first contact area can directly contact a further of said energy storage devices, in particular the adjacent energy storage device of the same battery, particularly during the operation of the battery. It is particularly preferentially provided for the second contact area to be electrically connected or interconnected, particularly also force-fit, to the first contact area of said further energy storage device.

The first contact area and the second contact area of the same energy storage device are preferably arranged parallel to one another, particularly at a predefined distance. Said predefined distance is preferably less than 1 mm, further preferentially less than 0.5 mm, further preferentially less than 0.2 mm, further preferentially more than 0.01 mm. This preferential design provides the advantage of simplifying the interconnecting of adjacent energy storage devices.

Alternatively, the second contact area is substantially arranged in the same plane as the first contact area of the same energy storage device. This preferential design provides the advantage of simplifying the interconnecting of adjacent energy storage devices.

In some conventional batteries, their energy storage devices are electrically connected or interconnected together by one or more interconnection means, usually configured as busbars, power cables, conductor lines or application-specific metallic bodies. Such interconnection means need to be manufactured, stockpiled, procured, etc., which goes hand in hand with costs.

The first contact area and the second contact area of two inventive, particularly adjacent, energy storage devices of the same battery allow their electrical interconnecting without any further interconnection means. Dispensing with such interconnection means saves the associated costs, hence accomplishing the objective on which the invention is based.

The design of the energy storage device with a first contact area and a second contact area as described above provides the further advantage of the interconnecting, or operation respectively, of two adjacent energy storage devices being accompanied by lower electrical losses, particularly due to the lower total contact resistance associated with a lower number of electrical connections and/or transitions,
here only with one contact resistance from the second contact area of the first energy storage device to the first contact area of the second energy storage device,
instead of the previous one contact resistance from the first conventional energy storage device to one of said interconnection means and a second contact resistance from the interconnection means to the second conventional energy storage device.

In the terms of the invention, an electrochemical electrode assembly is to be understood as a device which serves in particular in the providing of an electrical voltage, particularly a terminal voltage. To that end, the electrode assembly comprises at least two electrodes of different polarity. These electrodes of different polarity are distanced from one another by an ion-conducting separator, wherein the separator is not conductive to electrons. The electrode assembly is designed to convert stored chemical energy into electrical energy prior to the electrode assembly making said electrical energy available to a load, particularly an electric motor of a motor vehicle. The electrode assembly is preferably designed to convert electrical energy into chemical energy and store same as chemical energy. This design is also referred to as a rechargeable electrode assembly.

Two electrodes of different polarity are spaced apart in the electrode assembly by a separator. The separator is permeable to ions, however not to electrons.

The separator preferably contains at least a portion of the electrolyte and/or conducting salt. The electrolyte is preferably formulated without a liquid portion, particularly after the electrode assembly is sealed. The conducting salt preferably comprises lithium ions. It is particularly preferable for the lithium ions to be introduced, respectively intercalated, in the negative electrode during charging and expelled again during discharging.

One of said electrodes preferably comprises an in particular metallic collector foil as well as an active mass. The active mass is applied to at least one side of the collector foil. When the electrode assembly is charged or discharged, electrons are exchanged between the collector foil and active mass. At least one conductor tab is preferably connected, particularly materially, to the collector foil, particularly integrally formed with same. It is particularly preferable for a plurality of conductor tabs to be connected, particularly materially, to the collector foil. This embodiment provides the advantage of reducing the number of electrons which flow through a conductor tab per unit of time.

In the terms of the invention, a housing is to be understood as a device which is in particular designed to at least partially, preferably predominantly, particularly preferentially substantially completely accommodate the electrode assembly. The housing is in particular designed to delimit the electrode assembly relative the environment. The housing is in particular designed to counter an exchange of material between the environment and the electrode assembly. In the present case, the housing is of substantially cuboid configuration. The housing comprises at least one first housing wall and one second housing wall which are arranged substantially perpendicular to one another. The second housing wall is preferably arranged relative the housing such that it can contact a second of said energy storage devices adjacently disposed within the battery. The housing walls are designed to delimit an interior space of the housing, particularly with respect to the environment, wherein the interior space is provided to accommodate the electrode assembly at least partially, preferably predominantly, particularly preferentially substantially completely.

For the further description, the terms “length” and “width” will be established for said housing walls, wherein the length of one of said housing walls is greater than its width, wherein the length of one of said housing walls is measured transverse to the stacking direction as described further below, wherein the width is measured perpendicular to the length of the same housing wall. The area, particularly the width, of the second housing wall is preferably greater than the area, particularly the width, of the first housing wall. It is particularly preferential for the second housing wall to form the largest lateral area of the housing.

In the terms of the invention, a cell terminal is to be understood as a device which serves particularly in the electrical contacting of the electrode assembly. The cell terminal is electrically connectable, particularly materially, to at least one of the electrodes of the electrode assembly. The cell terminal is formed from a metal or from carbon. The cell terminal is formed as a solid body or with a coated, particularly metal-coated, core. The cell terminal extends at least sectionally into the environment of the energy storage device from the housing, its first housing wall respectively. A distinction is made in the present case between a first cell terminal of a first polarity and a second cell terminal of a second polarity. The cell terminal is in particular connected to the first housing wall.

In the terms of the invention, a contact area is to be understood as a lateral area section of one of said cell terminals which serves in particular the electrical connection of the energy storage unit to a further, particularly adjacent, said energy storage device or a load, particularly an electric motor of a motor vehicle. To this end, the contact area is accessible or can be electrically contacted from the environment of the energy storage device. A distinction is made in the present case between a first contact area of a first polarity and a second contact area of a second polarity. The contact area is in particular disposed outside of the housing.

In the terms of the invention, a connecting leg is to be understood as a section of the second cell terminal which extends into the environment of the energy storage device, extending sectionally beyond the second housing wall into the environment of the energy storage device. The connecting leg extends along a second limb axis which is particularly arranged substantially perpendicular to the second housing wall. The section of the connecting leg which extends into the environment beyond the second housing wall preferably comprises at least one part, preferably the largest part, of the second contact area. In so doing, the second normal vector \vec{N₂} exhibits the same direction to the second contact area as the first normal vector \vec{N₁} to the first contact area. The second normal vector \vec{N₂} has a reversed orientation to the first normal vector \vec{N₁}. The section of the connecting leg which extends beyond the second housing wall into the environment comprising at least a part, preferably the largest part, of the second contact area enables, or simplifies respectively, the electrical connection of the second contact area to the first contact area of an adjacent said energy storage devices.

In the terms of the invention, a battery is to be understood as a device which serves in particular the electrical supply of a load, particularly an electric motor of a motor vehicle. To this end, the battery comprises two or more of said interconnected energy storage devices. The at least two energy storage devices are arranged adjacent to one another, wherein the second housing wall of the first energy storage device contacts the adjacent second energy storage device. The at least two energy storage devices of the battery extend in the “stacking direction,” wherein the stacking direction is aligned substantially perpendicular to the second housing wall.

The following will describe preferential further developments of the invention.

At least one of the electrodes of the electrode assembly, particularly preferentially at least one cathode, preferably comprises a compound of the LiMPO₄ formula, whereby M is at least one transition metal cation from the first row of the periodic table of the elements. The transition metal cation is preferably selected from among the group consisting of Mn, Fe, Ni and Ti or a combination of these elements. The compound preferably exhibits an olivine structure, preferably primary olivine, whereby Fe is particularly preferential.

In a further embodiment, preferably at least one electrode of the electrode assembly, particularly preferentially at least one cathode, comprises a lithium manganate, preferably LiMn₂O₄ of spinel type, a lithium cobalate, preferably LiCoO₂, or a lithium nickelate, preferably LiNiO₂, or a mixture of two or three of these oxides, or a lithium-mixed oxide containing manganese, cobalt and nickel.

In accordance with a first preferential embodiment, the at least one separator which does not conduct or only poorly conducts electrons consists of an at least partially material-permeable substrate. The substrate is preferably coated on at least one side with an inorganic material. An organic material which is preferably developed as a non-woven fabric is preferably used as the at least partially material-permeable substrate. The organic material, which preferably comprises a polymer and particularly preferentially a polyethylene terephthalate (PET) is coated with an inorganic, preferably ion-conducting material which further preferably conducts ions in a temperature range of −40 C to 200° C. The inorganic material preferably comprises at least one compound from the group of oxides, phosphates, sulfates, titanates, silicates, aluminosilicates with at least one of the elements Zr, Al, Li, particularly preferably zirconium oxide. Zirconium oxide in particular serves the separator's material integrity, nanoporosity and flexibility. Said inorganic, ion-conducting material preferably comprises particles having a maximum diameter of less than 100 nm. This embodiment provides the advantage of improving the stability of the electrode assembly at temperatures higher than 100° C. Such a separator is sold for example in Germany by Evonik AG under the trade name of “Separion.”

In accordance with a second preferred embodiment, the at least one separator which does not conduct or only poorly conducts electrons but which is conductive to ions consists at least largely or completely of a ceramic, preferably an oxide ceramic. This embodiment provides the advantage of improving the stability of the electrode assembly at temperatures higher than 100° C.

In accordance with a first preferred design, the electrode assembly is configured as an electrode coil. This design provides the advantage of simple manufacturability, particularly due to the processability of linear electrodes. This design provides the advantage of being able to easily increase the charging capacity of the electrode assembly, indicated for example in ampere-hours [Ah] or watt-hours [Wh], more infrequently in coulomb [C], by means of further coils. The electrode assembly is preferably configured as a flat-wound electrode. The present preferred design provides the advantage of said flat-wound electrode being able to be arranged in space-saving manner next to a further flat-wound electrode, particularly within a battery.

In accordance with a further preferred design, the electrode assembly is designed as a substantially cuboid electrode stack. The electrode stack exhibits a predefined sequence of stacked sheets, wherein two electrode sheets of different polarity are separated by a separator sheet. Each electrode sheet is preferably connected, particularly materially, to a current conduction device, particularly preferentially formed integrally with the current conduction device. Preferably, electrode sheets of like polarity are in particular electrically connected together by means of a common current conduction device. This design to the electrode assembly provides the advantage of being able to easily increase the charging capacity of the electrode assembly, indicated for example in ampere-hours [Ah] or watt-hours [Wh], more infrequently in coulomb [C], by adding further electrode sheets. It is particularly preferential for at least two separator sheets to be connected together and enclose a limiting edge of an electrode sheet arranged between said separator sheets. Such an electrode assembly having a continuous, in particular serpentine separator is described in WO 2011/020545. This preferential design provides the advantage of countering a parasitic current originating from said limiting edge to an electrode sheet of different polarity.

Preferably, the energy storage device has a charging capacity of at least 3 ampere-hours [Ah], further preferentially of at least 5 Ah, further preferentially of at least 10 Ah, further preferentially of at least 20 Ah, further preferentially of at least 50 Ah, further preferentially of at least 100 Ah, further preferentially of at least 200 Ah, further preferentially of at the most 500 Ah. This design provides the advantage of improving the operating duration of the load supplied by the energy storage device, particularly designed as an electric motor of a motor vehicle.

Preferably, a current of at least 50 A, further preferentially of at least 100 A, further preferentially of at least 200 A, further preferentially of at least 500 A, further preferentially of at the most 1000 A can be at least intermittently withdrawn from the energy storage device, preferably over at least one hour. This design provides the advantage of improving the efficiency of the load supplied by the energy storage device, particularly designed as an electric motor of a motor vehicle.

The energy storage device can preferably at least intermittently provide a voltage, particularly a terminal voltage, of at least 1.2 V, further preferentially of at least 1.5 V, further preferentially of at least 2 V, further preferentially of at least 2.5 V, further preferentially of at least 3 V, further preferentially of at least 3.5 V, further preferentially of at least 4 V, further preferentially of at least 4.5 V, further preferentially of at least 5 V, further preferentially of at least 5.5 V, further preferentially of at least 6 V, further preferentially of at least 6.5 V, further preferentially of at least 7 V, further preferentially of at the most 7.5 V. It is particularly preferable for the energy storage device to comprise lithium and/or lithium ions. This design provides the advantage of improving the energy storage device's energy density.

Preferably, the energy storage device can be operated at least intermittently, particularly over at least one hour, at an ambient temperature of between −40° C. and 100° C., further preferentially between −20° C. and 80° C., further preferentially between −10° C. and 60° C., further preferentially between 0° C. and 40° C. This design provides the advantage of the most unrestricted deploying or use of the energy storage device to supply a load, particularly an electric motor of a motor vehicle or a stationary system or machine.

The energy storage device preferably has a gravimetric energy density of at least 50 Wh/kg, further preferentially of at least 100 Wh/kg, further preferentially of at least 200 Wh/kg, further preferentially of less than 500 Wh/kg. The electrode assembly preferably comprises lithium ions. This design provides the advantage of improving the energy storage device's energy density.

In accordance with one preferred embodiment, the energy storage device is provided for installation into a vehicle having at least one electric motor. The energy storage device is preferably provided for supplying said electric motor. It is particularly preferential for the energy storage device to be provided to at least intermittently supply an electric motor of a hybrid or electric vehicle's drive train. This design offers the advantage of improving the supplying of the electric motor.

In accordance with a further preferred embodiment, the energy storage device is provided for use in a stationary battery, particularly in a buffer storage, as a device battery, industrial battery or starter battery. The charging capacity of the energy storage device for these applications preferably amounts to at least 3 Ah, particularly preferably to at least 10 Ah. This design provides the advantage of improving the supplying of a stationary load, particularly a stationary mounted electric motor.

In accordance with one preferred further development, at least one of the housing walls is formed from a plastic and/or a metal. The plastic is preferably fiber-filled, particularly with glass fibers, aramide fibers, carbon fibers and/or mineral wool. The housing wall preferably has a minimum wall thickness of 0.5 mm. This preferred further development provides the advantage of the housing being able to provide a minimum mechanical protection for the electrode assembly.

In accordance with one preferential further development, the first cell terminal, or its first contact area respectively, is in particular electrically accessible from the environment of the energy storage device. The first cell terminal preferably extends at least sectionally into the environment from the first housing wall, particularly preferentially at least 1 mm. The first normal vector \vec{N₁} of the first contact area forms a predefined, preferably substantially right angle with the first housing wall. The first contact area preferably comprises aluminum, nickel, iron, copper or an alloy having at least one of the cited metals, particularly preferably a coating of nickel, silver or gold. This preferential development provides the advantage of simplifying the interconnecting of the energy storage device to a further, particularly adjacent, said energy storage device.

The first contact area preferably covers more than a quarter of the length of the first housing wall, further preferably more than a third, further preferably more than half, further preferably less than ⅘ of the first housing wall. This preferential design provides the advantage of reducing the first contact area current density.

In accordance with one preferential further development, the second cell terminal extends into the environment from the first housing wall. The second cell terminal preferably comprises a first leg which extends along a first limb axis, wherein the first limb axis is arranged substantially perpendicular to the first housing wall. Although the first leg is also electrically accessible particularly from the environment of the energy storage device, it does not bear the second contact area. The connecting leg extends at least sectionally outward from the first limb over the second housing wall into the environment of the energy storage device along its second limb axis. The second limb axis is aligned substantially perpendicular to the second housing wall and/or substantially perpendicular to the first limb axis. The connecting leg bears the second contact area. In so doing, the second normal vector \vec{N₂} exhibits the same direction to the second contact area as the first normal vector \vec{N₁} to the first contact area as well as reversed orientation. The second contact area and/or the connecting leg preferably comprises aluminum, nickel, iron, copper or an alloy having at least one of the cited metals, particularly preferably a coating of nickel, silver or gold. The section of the connecting leg extending beyond the second housing wall into the environment comprising at least a part, preferably the largest part, of the second contact area enables and/or simplifies the electrical connection of the second contact area to the first contact area of an adjacent said energy storage device.

The second contact area on the connecting leg is preferably arranged at a predetermined distance d₂ from the second housing wall or a second edge of the first housing wall respectively. It is particularly preferential for the predetermined distance d₂ to be dimensioned such that even with a gap between two adjacent energy storage devices, caused for instance by one of said projecting arrangements, the second contact area of the first energy storage device substantially fully covers the first contact area of the second energy storage device. This preferential configuration provides the advantage of enabling and/or simplifying the electrical connection of the second contact area to the first contact area of one of said adjacent energy storage devices.

Additionally or alternatively, the second contact area extends at least 0.01 mm, further preferentially at least 0.02 mm, further preferentially at least 0.05 mm, further preferentially at least 0.1 mm, further preferentially at least 0.2 mm, further preferentially at least 0.5 mm, further preferentially at least 1 mm, further preferentially at least 2 mm, further preferentially at the most 5 mm from the limb axis toward the first contact area of a further particularly adjacent energy storage device. This preferential design provides the advantage of the second contact area being more clearly recognizable when fitting.

Alternatively, the second contact area substantially fully covers one of the lateral areas of the connecting leg; the second contact area particularly does not extend from the connecting leg. This preferential design provides the advantage of simplifying the manufacture of the connecting leg. This preferential design provides the advantage of a certain freedom in positioning an adjacent energy storage device. This preferential design provides the advantage of simplifying the manufacture of the connecting leg.

The second contact area preferably extends over more than a quarter of the length of the first housing wall, further preferentially more than a third, further preferentially more than half, further preferentially less than ⅘ of the first housing wall. This preferential design provides the advantage of reducing the second contact area current density.

The area and the shape of the second contact area preferably corresponds to the area and the shape of the first contact area. This preferential design provides the advantage of being able to use as much of both contact areas as possible for supplying electrical energy from the electrode assembly.

In accordance with one preferential further development, the housing comprises at least one or more guide devices. The at least one guide device is designed to guide or receive an independent connection device for connecting a plurality of particularly electrically insulated energy storage devices. This preferred development provides the advantage of improving the cohesion of a plurality of said energy storage devices.

The at least one guide device is preferably arranged on a first housing wall, particularly preferentially connected, particularly materially, to the first housing wall. This preferential design provides the advantage of reducing the expenditure involved in producing the housing with guide device. This preferential design provides the advantage of improving the housing's anchoring within the battery.

The guide device is preferably comprised of the same material as the housing. This preferential design provides the advantage of reducing the expenditure involved in producing the housing.

A plurality of said guide devices are preferably arranged at different positions on the first housing wall, particularly preferentially with predetermined, in particular equal, distances between two respective guide devices. This preferential design provides the advantage of being able to better distribute forces on the housing from a plurality of said connection devices, particularly when interlocking adjacent such energy storage devices.

The at least one guide device is preferably designed as a ring or a substantially cylindrical sleeve. This preferential design provides the advantage of simplifying the guiding of the connection device. This preferential design provides the advantage of simplifying the battery's assembly.

Preferably, an insulating means, in particular configured as an electrically insulating bushing, can be inserted into the guide device. The insulating means is preferably produced from a polymer material. This preferential design provides the advantage of impeding an electrical short-circuit which might occur when at least one housing has the electrical potential of an electrode assembly accommodated in the housing.

In accordance with one preferred further development, the housing exhibits an arrangement of projections comprising at least two particularly ribbed projections. The projection arrangement preferably extends from the second housing wall. The projection arrangement is preferably designed to dissipate heat from the electrode assembly and/or reinforce the housing. The projection arrangement preferably comprises a plurality of ribbed projections which extend particularly over the largest part of the length or width of the second housing wall and are spaced apart from each other, particularly equally. With this configuration, the ribbed projections are suited to conducting a flow of fluid, particularly a flow of air, to dissipate heat from the electrode assembly. With this configuration, the ribbed projections are suited to act as a heat sink for the electrode assembly and release thermal energy to the fluid flow. The projections preferably exhibit a substantially cylindrical, conical, trapezoidal or rectangular cross section. The projections are preferably configured from a metal, particularly preferentially aluminum and/or copper. The present preferential development provides the advantage of improving the dissipation of heat from the electrode assembly. The present preferential development provides the advantage of improving the rigidity, or the bending moment resistance respectively, of the second housing wall.

In accordance with one preferred further development, the first cell terminal is designed for releasably force-fit connecting and electrical connecting to a further of said energy storage devices, particularly to the second cell terminal of the further energy storage device.

The first cell terminal preferably comprises one, two or a plurality of threads, particularly designed as female threads, which open to the first contact area or are accessible through the first contact area respectively.

Alternatively, the first cell terminal comprises one, two or a plurality of cavities which
open to the first contact area or are accessible through the first contact area respectively,
are each of substantially cylindrical design,
respectively extend along a longitudinal axis aligned substantially perpendicular to the first housing wall,
respectively exhibit a collar or projection adjacent to the first contact area which extends to the longitudinal axis and which is designed for force-fitting and/or form-fitting with a rivet.

The releasable force-fit connection of the first cell terminal of a first of said energy storage devices to the second cell terminal of a second of said energy storage devices preferably ensues by means of a bolt or rivet. This preferential development provides the advantage of simplifying the interconnecting of two, particular adjacent, said energy storage devices. This preferential development provides the advantage of improving the cohesion of two, particular adjacent, said energy storage devices.

In accordance with a further preferred further development, the connecting leg is designed for releasably force-fit connecting and electrical connecting to a further of said energy storage devices, in particular the first cell terminal of the further energy storage device. The connecting leg preferably exhibits one, two or a plurality of through holes, each extending along a bore axis, wherein the bore axis is preferably aligned substantially perpendicular to the first housing wall. The through holes preferably open to the second contact area or are accessible through the second contact area respectively.

The through holes are preferably of oversize design or are configured as slotted holes, thus enabling two adjacent energy storage devices which are to be interconnected to be positioned at a certain tolerance. This preferential design provides the advantage of reducing manufacturing costs.

The releasable force-fit connection of the connecting leg to the first cell terminal of a further of said energy storage devices preferably ensues by means of a bolt or rivet. This preferential development provides the advantage of simplifying the interconnecting of two, particular adjacent, said energy storage devices. This preferential development provides the advantage of improving the cohesion of two, particular adjacent, said energy storage devices.

In accordance with one preferred further development, the first cell terminal is configured with one, two or a plurality of said threads and/or cavities accessible through the first contact area. The connecting leg is further configured with one, two or a plurality of said through holes accessible through the second contact area. At least one of said threads or one of said cavities respectively and at least one of said through holes are arranged relative each another such that a plane of symmetry which extends through the at least one thread and/or cavity and the at least one through hole is aligned substantially perpendicularly to the second housing wall. Preferably, a plurality of threads and/or cavities and just as many through holes are arranged relative each other such that said plane of symmetry which extends through the said at least one thread and/or cavity and the said at least one through hole is in each case aligned substantially perpendicular to the second housing wall. This preferential development provides the advantage of simplifying the interconnecting of two, in particular adjacent, energy storage devices, particularly of the same battery.

In accordance with one preferred further development, the first housing wall is delimited by a plurality of edges, particularly four. Preferably, a plurality of said edges form a rectangle. The first contact area is at least partly, preferably predominantly, particularly preferentially substantially completely disposed within said edges. The present preferred development provides the advantage of simplifying the interconnecting of two, particularly adjacent, energy storage devices, particularly of the same battery. The present preferred development provides the advantage of simplifying the adjacent arrangement of two, particularly adjacent, energy storage devices, particularly of the same battery.

In accordance with one preferred further development, the electrode assembly comprises at least one or more said conductor tabs. The second cell terminal is configured with a tab contact element. The tab contact element is designed for the electrical, particularly material, connection to at least one or more of said conductor tabs of the same polarity. The tab contact element is disposed within the housing. The tab contact element extends along the second housing wall, preferably over more than half its length, further preferably over more than ⅔ its length. Preferably, the tab contact element is essentially just as wide and/or long as at least one of said conductor tabs, whereby the length of the tab contact element, said conductor tab respectively, is measured transverse to the stacking direction. The present preferential development provides the advantage of reducing current density during the provision of electrical energy from the electrode assembly. The present preferential development provides the advantage of improving the dissipation of heat during the provision of electrical energy from the electrode assembly.

In accordance with one preferred further development, the housing has the electrical potential of one of the cell terminals, particularly the second cell terminal. To this end, one or more of said conductor tabs, particularly of a second polarity, are preferably electrically connected, particularly materially, to the housing. This preferential further development provides the advantage of impeding an unwanted relative motion between the electrode assembly and the housing, particularly upon impacts or vibrations during the operation of the energy storage device.

Said conductor tabs being electrically connected to the housing also enables, or simplifies respectively, the heat transfer between the electrode assembly and the housing. This preferential development provides the advantage of improving the dissipation of heat from the electrode assembly.

When the housing additionally comprises said arrangement of projections, one or more of said projections can be electrically insulated relative the housing of the adjacent energy storage device of the same battery by way of an insulating means, particularly configured as a polymer strip. The insulating means is preferably configured as a coating, deposit, strip, rail or adhesive. The insulating means is preferably form-fit or materially connected to the respective projection. The present preferential further development provides the advantage of impeding a short-circuit between two adjacent said energy storage devices. This preferential development provides the advantage of enabling a series connection of two adjacent energy storage devices.

The objective is also accomplished by a battery comprising two or more of said energy storage devices which is in particular intended for supplying a motor vehicle. A first of said energy storage devices is thereby disposed within the battery adjacent to a second of said energy storage devices. The second housing wall of the first energy storage device preferably contacts the adjacent second energy storage device. The neighboring arrangement of these energy storage devices and their configuration with the above-cited cell terminals enables simple interconnecting of the energy storage devices and thus lower expenditure during the manufacturing of the battery. In the adjacent arrangement of two of said energy storage devices, the connecting leg of the first energy storage device extends beyond its second housing wall over the first cell terminal, particularly over the first contact area, of the adjacent second energy storage device. In so doing, the second contact area of the connecting leg of the first energy storage device touches and makes electrical contact with the first contact area of the second energy storage device. Hence, the connecting leg of the first energy storage device is electrically connectable, or interconnectable respectively, to the first contact area of the second energy storage device.

The connecting leg of the first energy storage device can preferably also be force-fit connected to the first contact area of the second energy storage device. The connecting leg of the first energy storage device preferably comprises one or more of said through holes and the first contact area of the second energy storage device one or more of said threads, particularly configured as female threads or cavities. In this design, the force-fit connection can be created by means of one or more bolts or rivets, whereby one of said bolts or rivets is led through one of said through holes of the first energy storage device and can be screwed into one of said threads or one of said cavities of the second energy storage device.

Designing the battery with two or more of said energy storage devices is accompanied by the advantage of simplifying the interconnecting of the energy storage devices and thus being more economical. This design to the energy storage devices is accompanied by the advantage of improving the cohesion of two adjacent energy storage devices within the same battery and thus dispensing with at least some of the means used to mechanically stabilize the energy storage devices within the battery. Designing the battery with two or more of said energy storage devices is accompanied by the advantage of being able to interconnect two respective energy storage devices without any further design means, thus accomplishing the underlying objective.

The through holes are preferably of oversize design or are configured as slotted holes, thus enabling two adjacent energy storage devices which are to be interconnected to be positioned at a certain tolerance. This preferential design provides the advantage of reducing manufacturing costs.

The use of these energy storage devices for the battery, each with a first contact area and a second contact area, provides the further advantage of the interconnecting, or operation respectively, of two adjacent energy storage devices being accompanied by lower electrical losses, particularly due to the lower total contact resistance associated with a lower number of electrical connections and/or transitions,
here only with one contact resistance from the second contact area of the first energy storage device to the first contact area of the second energy storage device,
instead of the previous one contact resistance from the first conventional energy storage device to one of said interconnection means and a second contact resistance from the interconnection means to the second conventional energy storage device.

In accordance with one preferential further development of the battery, the housing of at least the first energy storage device has the electrical potential of the second cell terminal. To this end, one or a plurality of said conductor tabs, particularly of a second polarity, are preferably electrically connected, particularly materially, to the housing. The present preferential development provides the advantage of impeding an unwanted relative motion between the electrode assembly and the housing, particularly upon impacts or vibrations during the operation of the energy storage device. This preferential further development provides the advantage of improving the endurance, or the functioning of the battery respectively, particularly upon impacts or vibrations during operation.

Said conductor tabs being electrically connected to the housing also enables and/or improves the heat transfer between the electrode assembly and the housing. The present preferential development provides the advantage of improving the dissipation of heat from the electrode assembly. This preferential development provides the advantage of improving the endurance, or the functioning of the battery respectively.

The housing of the first energy storage device preferably additionally comprises said arrangement of projections. One or more of said projections can in each case be electrically insulated relative the housing of the second, particularly adjacent, energy storage device of the same battery by way of a respective insulating means. When the housing of the second energy storage device likewise comprises said projection arrangement, then also one or more of said projections can in each case be electrically insulated relative the housing of the first, particularly adjacent, energy storage device of the same battery by way of a respective insulating means. The insulating means is preferably configured as a coating, strip, rail, deposit or adhesive. The insulating means is preferably form-fit or materially connected to the respective projection. The present preferential development provides the advantage of impeding a short-circuit between two adjacent said energy storage devices, each of the housings of which have the potential of the second cell terminal. This preferential further development provides the advantage of enabling a series connection of two adjacent energy storage devices.

One preferential further development of the battery comprises one or more of said connection devices. The two or more of said energy storage devices each further comprise at least one or more of said guide devices. At least one of said connection devices is led through a respective one of said guide devices of two adjacent energy storage devices. The guide devices of adjacent energy storage devices are preferably arranged relative one another such that an axis through said guide devices is aligned substantially perpendicular to one of the second housing walls.

Preferably, two adjacent energy storage devices are interlocked against each other by means of at least one or more of said connection devices. The connection devices are preferably respectively configured as particularly metallic, particularly cylindrical tension rods. This preferential development provides the advantage of improving the cohesion of the energy storage devices during battery operation.

When the housing has the electrical potential of the second cell terminal in the case of at least one of the energy storage devices, the connection means can then be electrically insulated relative the guide devices by way of one or more insulating means, particularly configured as a ring or a bushing. This preferential design provides the advantage of being able to more durably form the connection device with a metal.

The objective is also accomplished by a method for the electrical interconnecting of two of said energy storage devices, particularly during the manufacturing of the battery. The method comprises the steps of:

S1 arranging the two energy storage devices in such a manner, in particular adjacent one another, such that the connecting leg of the first energy storage device comes into electrical contact with the first contact area of the second energy storage device, wherein particularly at least one of said through holes of the first energy storage device is arranged adjacent, particularly substantially concentrically, to at least one of said threads or cavities respectively of the second energy storage device,

S2 connecting, in particular releasably, particularly force-fit and/or electrically, the connecting leg of the first energy storage device to the first contact area of the second energy storage device, particularly by means of at least one bolt or at least one rivet respectively, in particular subsequent step S1,

preferably

S3 arranging an insulating means about the first cell terminal of the second energy storage device, in particular prior to step S1, and/or

S4 arranging, particularly passing, at least one of said connection devices through one of said guide devices of the first energy storage device as well as one of said guide devices of the second energy storage device.

The insulating means of step S3 serves in particular to impede a short-circuit of the first energy storage device with the second energy storage device, caused in particular by a foreign body or an electrically conductive liquid. The insulating means thus comprises an electrically insulating section which extends along the first leg of the second cell terminal and in particular substantially fully covers said first leg relative the first cell terminal.

This method provides the advantage of electrically interconnecting two of said energy storage devices without any interconnection means. Dispensing with such interconnection means saves the associated costs, thus accomplishing the underlying objective.

The use of these energy storage devices for the battery, each with a first contact area and a second contact area, provides the further advantage of the interconnecting, or operation respectively, of two adjacent energy storage devices being accompanied by lower electrical losses, particularly due to the lower total contact resistance associated with a lower number of electrical connections and/or transitions,
here only with one contact resistance from the second contact area of the first energy storage device to the first contact area of the second energy storage device,
instead of the previous one contact resistance from the first conventional energy storage device to one of said interconnection means and a second contact resistance from the interconnection means to the second conventional energy storage device.

Preferably, steps S1 and S2 are performed multiple times, in particular more frequently with an increasing number of energy storage devices.

Further advantages, features and possible applications of the present invention will follow from the following description in conjunction with the figures, which show:

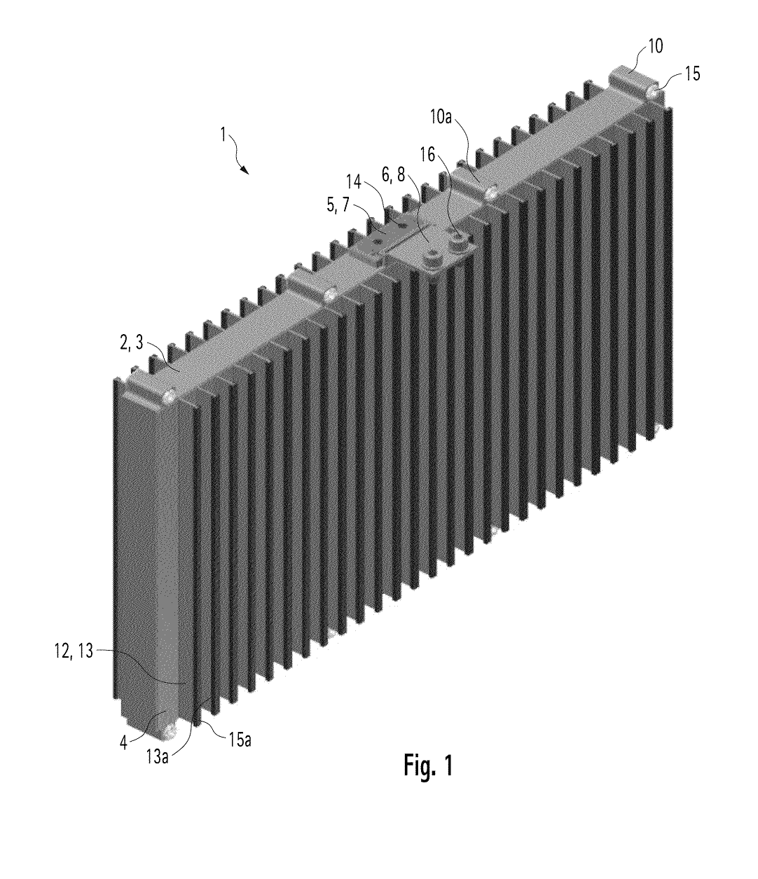

FIG. 1 a preferred embodiment of an energy storage device,

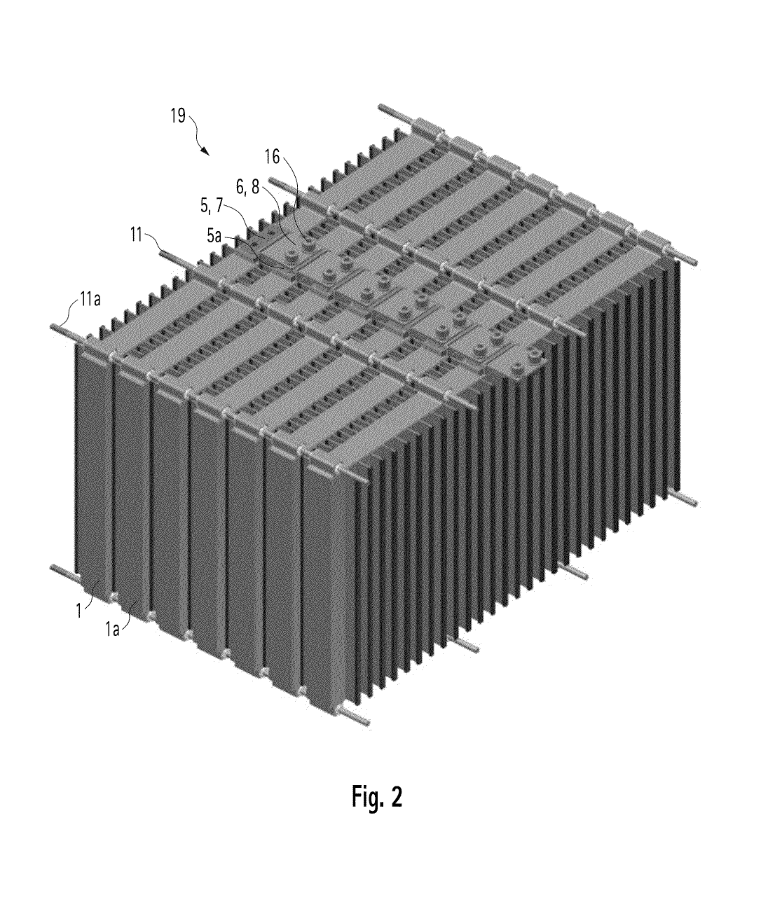

FIG. 2 a battery with a plurality of interconnected energy storage devices of preferential design,

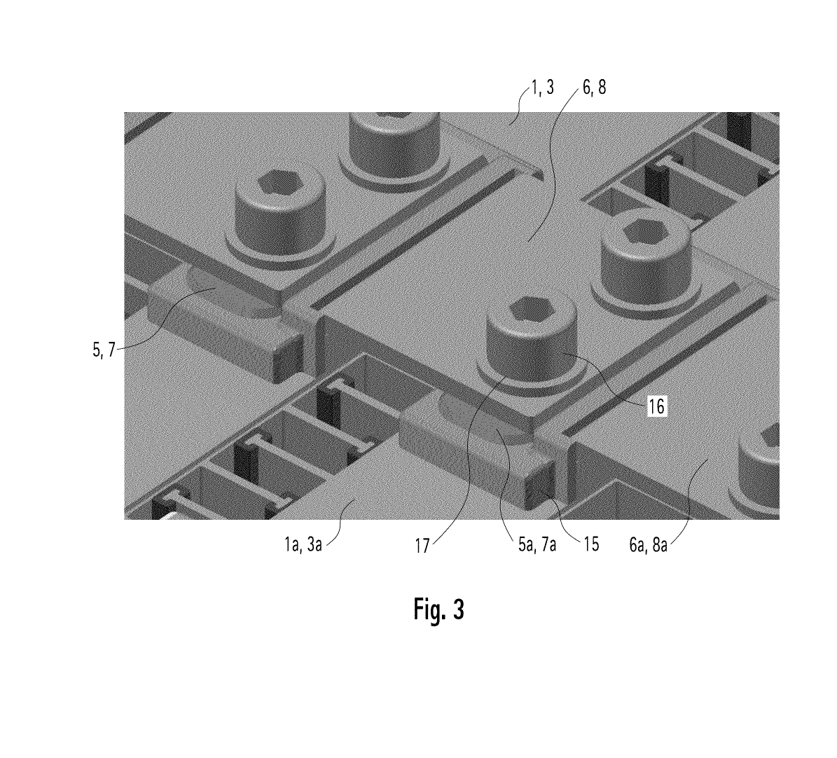

FIG. 3 a detail from FIG. 2,

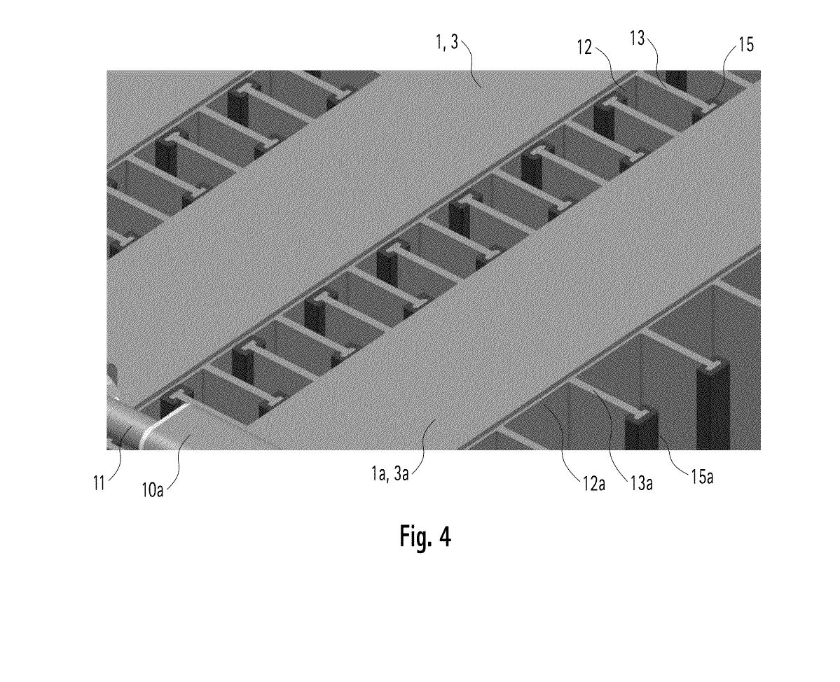

FIG. 4 a further detail from FIG. 2,

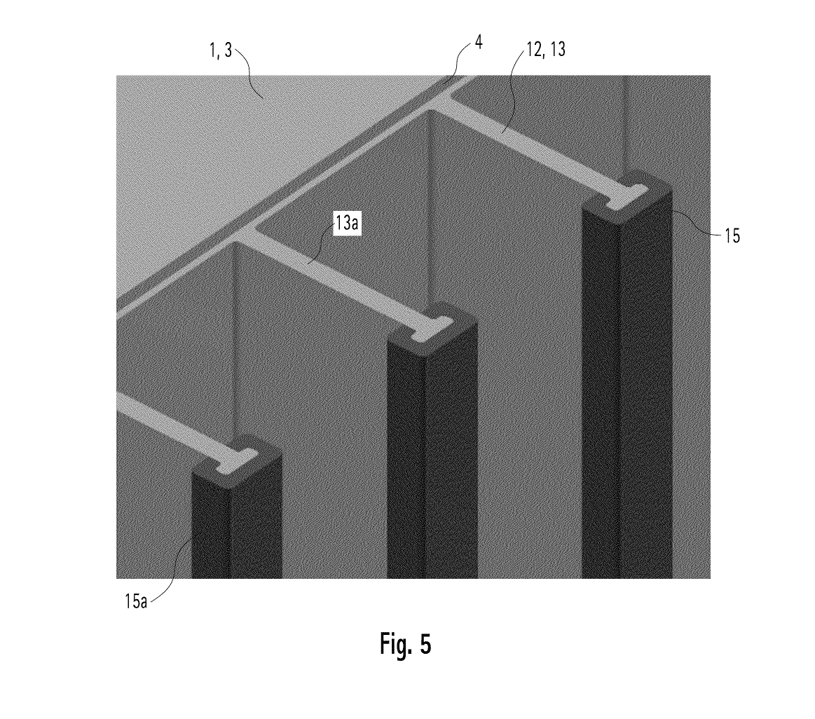

FIG. 5 a detail from FIG. 4,

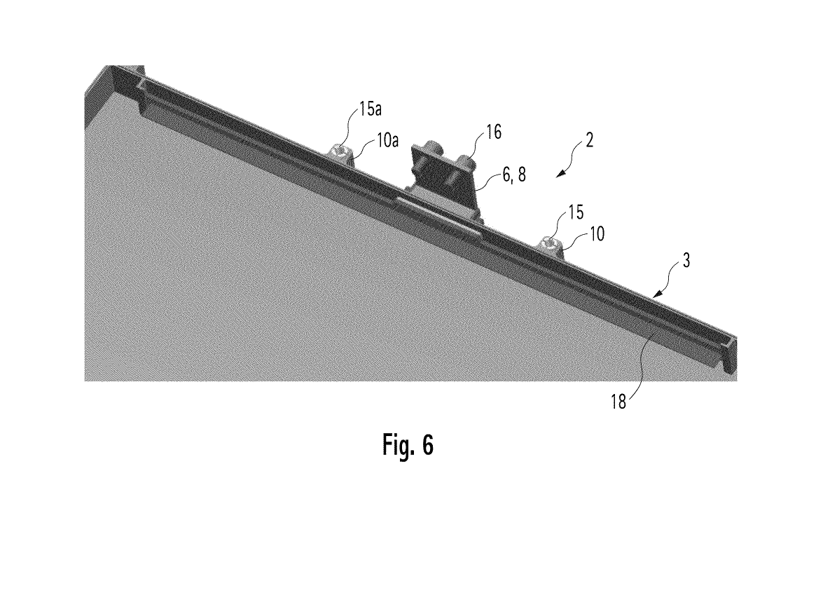

FIG. 6 an opened housing of an energy storage device of preferential design,

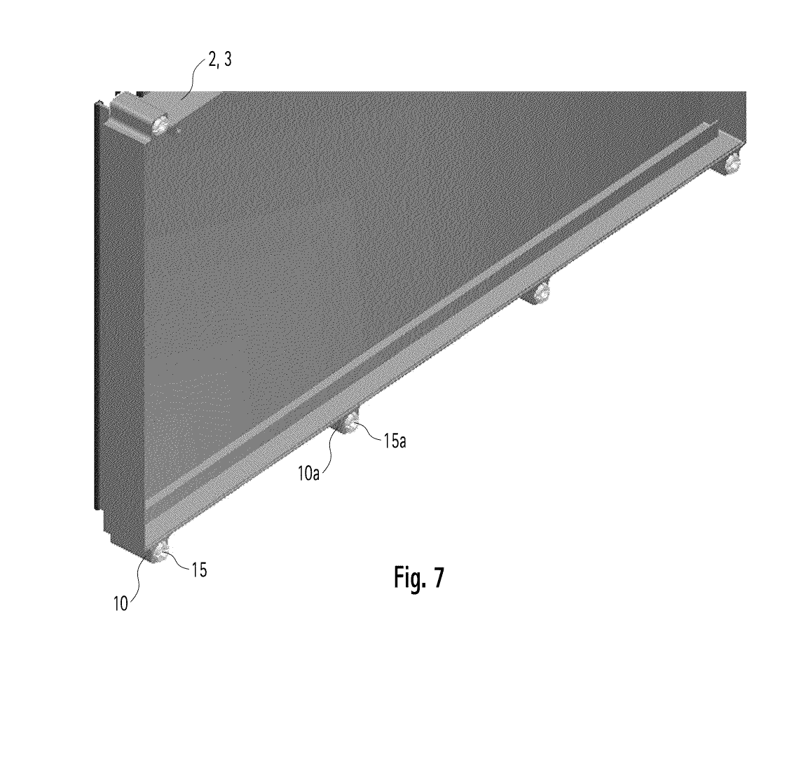

FIG. 7 another view of the housing of FIG. 6,

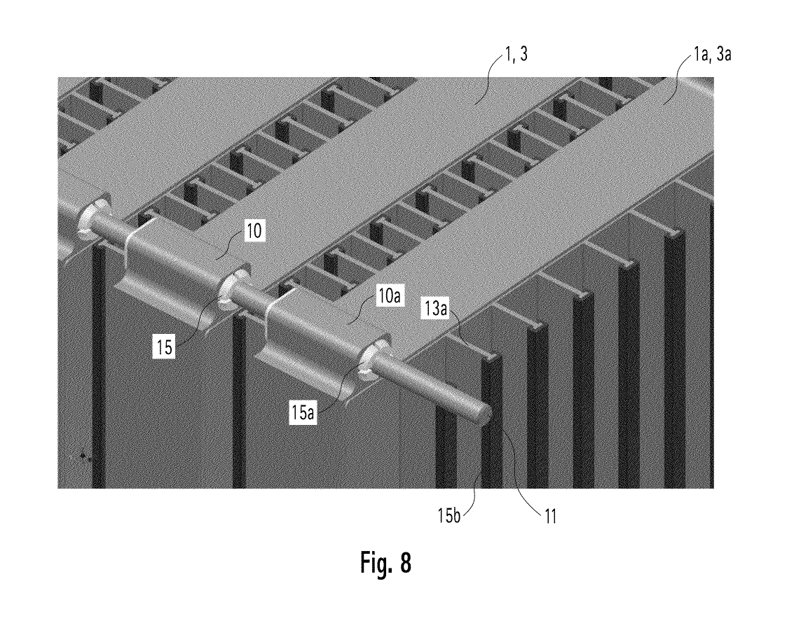

FIG. 8 a further detail from FIG. 2,

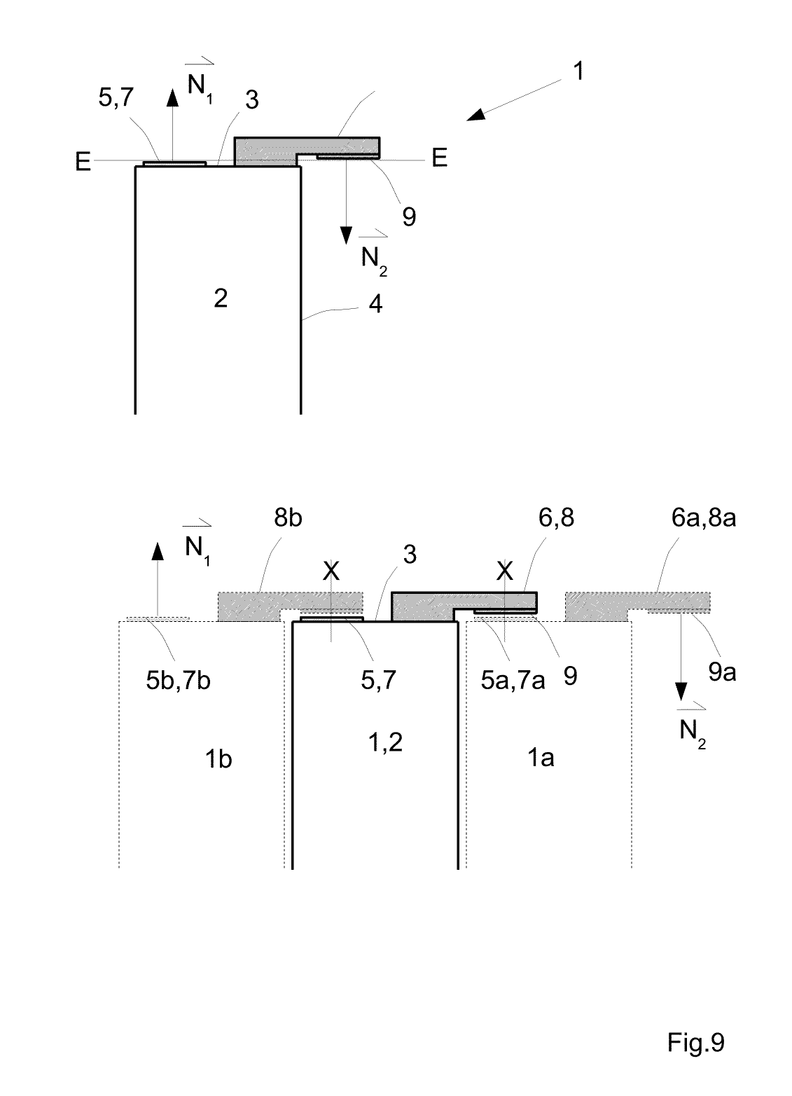

FIG. 9 a schematic view of the cell terminals of an energy storage device of preferential design,

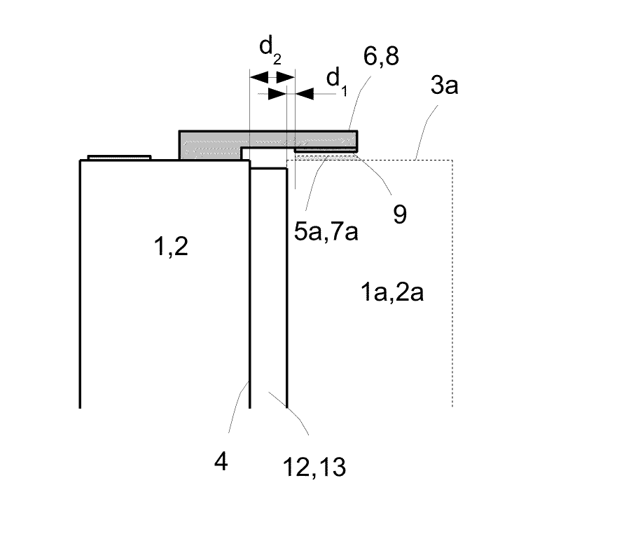

FIG. 10 a schematic view of the arrangement of the second contact area on the connecting leg relative the first contact area of a second energy storage device,

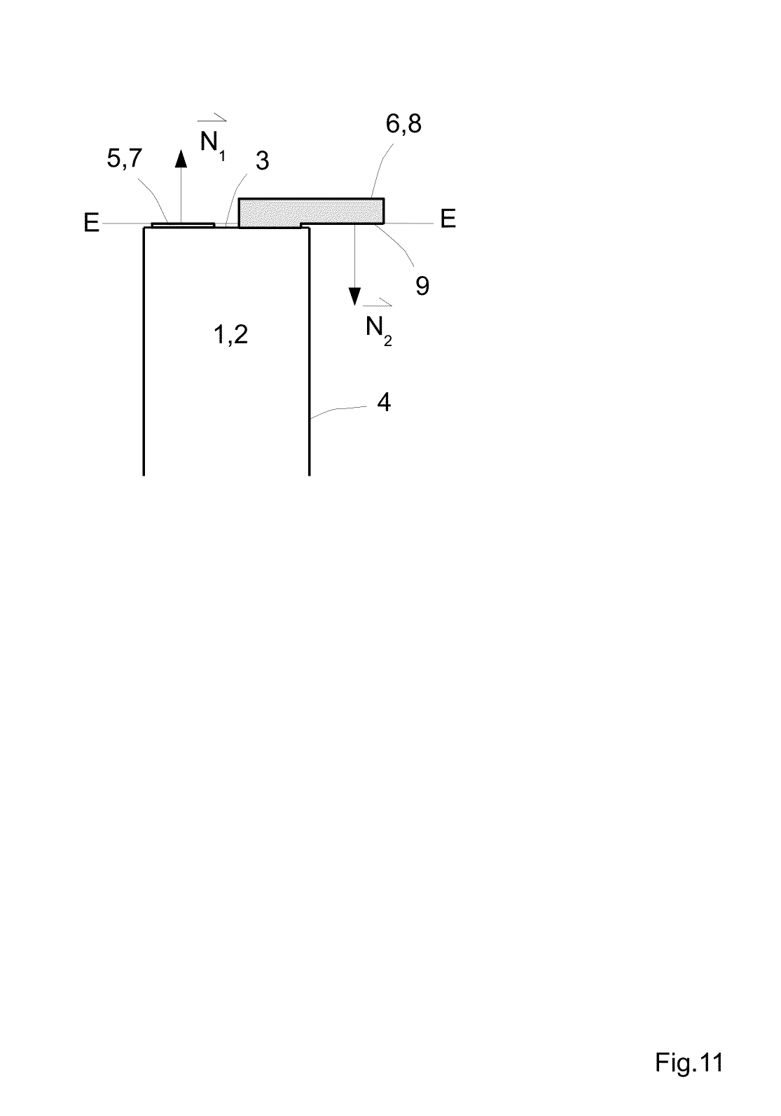

FIG. 11 a schematic view of an alternative preferential design of the connecting leg compared to FIGS. 9 and 10.

FIG. 1 shows a preferred embodiment of the energy storage device 1. Shown is the housing 2 of the energy storage device 1 with a first housing wall 3 and a second housing wall 4. The first housing wall 3 is arranged substantially perpendicular to the second housing wall 4. The electrode assembly is electrically and heat-conductively connected to the housing 2.

The first housing wall 3 bears the first cell terminal 5 and the second cell terminal 6. In particular, the first housing wall 3 is integrally formed with the second cell terminal 6. The first cell terminal 5 is formed with first contact area 7 as well as two threads 14, whereby the two threads 14 are accessible through the first contact area 7. The threads 14 extend substantially perpendicular to the first contact area 5 and are configured as female threads. The second cell terminal 6 comprises the connecting leg 8 which extends from the first housing wall 3 beyond the second housing wall 4.

The connecting leg 8 comprises two through holes into which bolts 16 are inserted. The through holes are preferably oversized or are designed as slotted holes. Thus, two adjacent energy storage devices which are to be interconnected can be positioned at a certain tolerance. This preferential design provides the advantage of reducing manufacturing costs.

Not seen here is the second contact area on the underside of the connecting leg 8, whereby the two bolts 16 also extend through the second contact area. Nor is it apparent that the second contact area and the first contact area 5 are essentially arranged in the same plane.

The dotted line aligned substantially perpendicular to the second housing wall 4 indicates that the bolt 16 and the thread 14 have the same plane of symmetry. The same also applies to the adjacent bolt and adjacent thread.

The first housing wall 3 bears a plurality of guide devices 10, each having a bore hole aligned substantially perpendicular to the second housing wall 4. A plurality of said guide devices 10 are arranged along the first housing wall 3. An insulating bushing 15 is inserted into the guide device 10 which electrically insulates the not-shown connection device relative the guide device 10. This design simplifies and makes more economical the electrical interconnection of the energy storage device 1 depicted with a not-shown adjacent energy storage device in that interconnection means can be dispensed with.

The arrangement of projections 12 is heat-conductively connected to the second housing wall 4. Each of the projections 13, 13a are covered by an insulating strip 15a which serves to electrically insulate the projections 13, 13a relative an adjacent energy storage device. The projections 13, 13a further serve to reinforce the housing 2.

FIG. 2 shows a battery 19 having a plurality of interconnected energy storage devices 1, 1a of preferential design. The energy storage devices 1, 1a are configured commensurately to the energy storage device of FIG. 1. Depicted is the mechanical connection and electrical interconnection of energy storage device 1 to the adjacent energy storage device 1a. Thus, the connecting leg 8 of the first energy storage device 1 extends over the first cell terminal 5a of the second energy storage device 1a. The second contact area covered by the connecting leg 8 of the first energy storage device 1 is electrically and force-fit connected to the first contact area 5a of the second energy storage device 1a by means of bolts 16. A plurality of connection devices 11, 11a are guided through the guide devices 10, 10a of the energy storage devices 1, 1a, wherein the connection devices 11, 11a are electrically insulated relative the guide devices 10, 10a.

FIG. 3 shows a detail from FIG. 2. The energy storage devices 1, 1a are configured commensurately to the energy storage device of FIG. 1. The connecting leg 8 of the first energy storage device 1 extends over the first cell terminal 5a, particularly over the first contact area 7a, of the second energy storage device 1a. The connecting leg 8 is bolted to the first cell terminal 5a of the second energy storage device 1a by means of bolts 16. An insulating means 15 is positioned around the first cell terminal 5a of the second energy storage device 1a. Said insulating means 15 serves to impede a short-circuit of the second energy storage device 1a caused in particular by a foreign body or an electrically conductive liquid. The insulating means 15 thus comprises an electrically insulating section which extends along the first leg of the second cell terminal 6a and in particular substantially fully covers said first leg relative the first cell terminal 5.

FIG. 4 shows a further detail from FIG. 2. The energy storage devices 1, 1a are configured commensurately to the energy storage device of FIG. 1. Each of said projection arrangements 12, 12a of the energy storage devices 1, 1a comprises a plurality of projections 13, 13a. Insulating means 15, 15a electrically insulate the projections 13, 13a relative the respective adjacent energy storage device. Said insulating means 15, 15a are configured as polymer strips and drawn over the free ends of the projections 13, 13a.

FIG. 5 shows a detail from FIG. 4. The energy storage device 1 is designed commensurately to the energy storage device of FIG. 1. Depicted is how the free ends of the projections 13, 13a terminate in a T-shape and the polymer strips 15, 15a engage around said T-shaped ends.

FIG. 6 shows an opened housing 2 of an energy storage device 1 of preferential design. The energy storage device 1 is designed commensurately to the energy storage device of FIG. 1. The second cell terminal 6 is configured with a conductor tab element 18. The conductor tab element 18 extends along the greater part of the first housing wall 3 for the best heat dissipation possible from the electrode assembly and lower current density upon the supplying of a load, particularly configured as an electric motor of a motor vehicle.

FIG. 7 shows another view of the housing of FIG. 6. A further housing wall which is arranged parallel to the first housing wall 3 likewise comprises a plurality of guide devices 10, 10a. The guide devices 10, 10a are integrally formed with the housing wall and furnished with insulating means 15, 15a.

FIG. 8 shows a further detail from FIG. 2. The energy storage devices 1, 1a are configured commensurately to the energy storage device of FIG. 1. Depicted is the mechanical connection and electrical interconnection of energy storage device 1 to the adjacent energy storage device 1a. A plurality of connection devices 11, 11a are guided through the guide devices 10, 10a of the energy storage devices 1, 1a, wherein insulating means 15, 15a electrically insulate the connection devices 11, 11a configured as electrically conductive tension rods relative the guide devices 10, 10a. Depicted is how the free ends of the projections 13, 13a terminate in a T-shape and the polymer strips 15, 15a engage around said T-shaped ends.

FIG. 9a, the upper half of FIG. 9, schematically shows the cell terminals 5, 6 of an energy storage device 1 of preferential design. The energy storage device 1 exhibits a housing 2 comprising a first housing wall 3 and a second housing wall 4. Said housing walls are arranged substantially perpendicular to each other.

The first cell terminal 5 and the second cell terminal 6 extend from the first housing wall 3. The first cell terminal 5 comprises the first contact area 7. The first normal vector \vec{N₁} to the first contact area 7 is arranged substantially perpendicular to the first housing wall 3. The second cell terminal 7 comprises the connecting leg 8 as well as the second contact area 9. The second normal vector \vec{N₂} points in the same direction as the first normal vector \vec{N₁} but is of opposite orientation. The second contact area 9 is arranged and aligned so as to enable contact, or electrical connection respectively, to the first contact area of a not-shown adjacent energy storage device. The plane E is parallel to the first contact area 7 and the second contact area 9.

The second contact area 9 extends approximately 1 mm from the connecting leg 8 toward the first contact area of a not-shown further, particularly adjacent, said energy storage device.

FIG. 9b, the lower half of FIG. 9, shows the energy storage device 1 according to FIG. 9a arranged between two adjacent energy storage devices 1a, 1b indicated by dotted lines.

The connecting leg 8 of the first energy storage device 1 projects over the first cell terminal 5a as well as its first contact area 7a of the adjacent energy storage device 1a. A gap which in practice is to be kept as small as possible is left between one of said second contact areas 7, 7a and one of said first contact areas 7, 7a solely for the purpose of aiding in better distinguishing the adjacent energy storage devices 1, 1a, 1b. The connecting leg 8 of the first energy storage device 1 can be electrically and force-fit connected or bolted respectively to the first cell terminal 5a of the adjacent second energy storage device 1a, which is represented by the perpendicular “X” line.

As before, the second normal vector \vec{N₂} to the second contact area 9a points in the same direction as the first normal vector \vec{N₁} to the first contact area 5b but is of opposite orientation.

The second contact area 9 extends approximately 0.5 mm from the connecting leg 8 toward the first contact area 7a of the further, particularly adjacent, said energy storage device 1a depicted by dotted lines.

FIG. 10 schematically shows the arrangement of the second contact area 9 on the connecting leg 8 relative the first contact area 5 of a second energy storage device 1a.

The second contact area 9 is spaced at a predetermined distance d₂ from the second housing wall 4. Said predetermined distance d₂ substantially corresponds to the sum of the distance d₁ of the first contact area 5a of the second energy storage device 1a from the left edge of the first housing wall 3a plus the distance between the energy storage devices 1 and 1a resulting from the arrangement of projections 12. This thus achieves the second contact area 9 substantially completely covering the first contact area 5a of the second energy storage device 1a.

FIG. 11 shows an alternative preferred design of the connecting leg 8 in relation to FIGS. 9 and 10. This connecting leg 8 substantially corresponds to the connecting leg of FIG. 9 with the difference of the second contact area 9 substantially fully covering one of the lateral areas of said connecting leg 8. This preferred design provides the advantage of simplifying the manufacture of the connecting leg without a projecting second contact area 9.

### LIST OF REFERENCE NUMERALS

1, 1a energy storage device
2, 2a housing
3 first housing wall
2, 2a second housing wall
5, 5a first cell terminal
6, 6a second cell terminal
7, 7a first contact area
8, 8a connecting leg
9, 9a second contact area
10, 10a guide device
11, 11a connection device
12, 12a projection arrangement
13, 13a projection of projection arrangement
14, 14a thread
15, 15a insulating means, insulating bushing, insulating strip
16, 16a bolt
17, 17a through hole
18 tab contact element
19 battery
\vec{N₁} first normal vector to the first contact area
\vec{N₂} second normal vector to the second contact area
E plane, parallel to the first contact area
d₁ distance of the first contact area from an edge of the first housing wall
d₂ distance of the second contact area from the second housing wall

1-12. (canceled)

13. An energy storage device configured as an electro-chemical secondary cell for a secondary battery for supplying energy to a motor vehicle, the energy storage device comprising:
an electrochemical electrode assembly configured to at least intermittently provide an electrical voltage;
a substantially cuboid housing configured to at least partially accommodate the electrode assembly, wherein the housing includes a first housing wall and a second housing wall, wherein the first and second housing walls are arranged substantially perpendicular to one another; and
a first cell terminal of a first polarity and a second cell terminal of a second polarity, wherein the energy storage device is configured such that the electrical voltage can be at least intermittently tapped at the cell terminals, wherein the cell terminals extend from the first housing wall, wherein the first cell terminal comprises a first contact area having a first normal vector,
wherein the second cell terminal includes a substantially plate-shaped connecting leg, wherein the connecting leg sectionally extends beyond the second housing wall, wherein the connecting leg comprises a second contact area having a second normal vector, and wherein the second normal vector has the same direction as the first normal vector and reversed orientation.

14. The energy storage device according to claim 13, wherein the energy storage device is one of a plurality of like energy storage devices, and wherein the housing comprises at least one guide device configured to guide and receive an independent connection device for connecting the plurality of like energy storage devices.

15. The energy storage device according to claim 13, wherein the housing includes a projection arrangement comprising at least two ribbed projections, wherein the projection arrangement extends from the second housing wall, wherein the projection arrangement is configured to dissipate heat from the electrode assembly and/or reinforce the housing.

16. The energy storage device according to claim 13, wherein
the energy storage device is one of a plurality of like energy storage devices,
at least one of (a) the first cell terminal is configured to releasably connect, via a force-fit connection, and electrically connect to a second cell terminal of a further of said plurality of like energy storage devices, and (b) the connecting leg is configured to releasably connect, via a force-fit connection, and electrically connect to a first cell terminal of a further of said plurality of like energy storage devices,
the first cell terminal includes at least one thread or cavity, and
the connecting leg includes at least one through hole.

17. The energy storage device according to claim 16, wherein the at least one thread or cavity arranged in the first contact area and the at least one through hole is disposed in the connecting leg,
wherein a plane of symmetry which runs through the at least one thread or cavity and through the at least one through hole is aligned substantially perpendicular to the second housing wall.

18. The energy storage device according to claim 13, wherein the first housing wall is delimited by four edges that form a rectangle, and the first contact area is at least partly disposed within said edges.

19. The energy storage device according to claim 13, wherein
the electrode assembly comprises at least one conductor tab,
the second cell terminal comprises a tab contact element configured to electrically and materially connect the at least one conductor tab, the tab contact element being disposed within the housing and extending along the second housing wall.

20. The energy storage device according to claim 13, wherein the energy storage device is configured such that the housing has the electrical potential of the second cell terminal.

21. A battery for supplying energy to a motor vehicle, the battery comprising:
at least one first energy storage device according to claim 13 and one second energy storage device according to claim 13,
wherein the first energy storage device is disposed adjacent to the second energy storage device,
wherein the connecting leg of the first energy storage device is configured to be electrically connectable, via a force-fit connection, to the first contact area of the second energy storage device via a bolt or a rivet.

22. The battery according to claim 21, wherein the battery is configured such that the housing of the first energy storage device has the electrical potential of the second cell terminal.

23. The battery according to claim 21, further comprising at least one independent connection device for connecting the first energy storage device to the second energy storage device, wherein the first energy storage device and the second energy storage device each comprise a guide device configured to guide and receive the at least one independent connection device, wherein the battery is configured such that the at least one connection device is guidable through the respective guide devices of the first energy storage device and the second energy storage device.

24. A method for electrically interconnecting a first energy storage device according to claim 13 and a second energy storage device according to claim 13 during the manufacturing of a battery, the method comprising:
arranging the first and second energy storage devices such that the connecting leg of the first energy storage device comes into electrical contact with the first contact area of the second energy storage device, wherein at least one through holes of the first energy storage device is disposed adjacent to at least one thread or cavity of the second energy storage device,
releasably connecting, via a force-fit and electrical connection, the connecting leg of the first energy storage device to the first contact area of the second energy storage device via a bolt or a rivet after the arranging the first and second energy storage devices.

25. The method according to claim 24, further comprising:
arranging an insulating means about the first cell terminal of the second energy storage device prior to the arranging the first and second energy storage devices.

26. The method according to claim 24, further comprising:
passing at least one independent connection device through a said guide device of the first energy storage device as well as a guide device of the second energy storage device.
